(19) United States
(12) Patent Application Publication
(10) Pub. No.: US 2025/0353741 A1
(43) Pub. Date: Nov. 20, 2025

(54) HYDROGEN PRODUCTION BY STEAM REFORMING OF DODECANE USING NICKEL-RED MUD CATALYST

(71) Applicant: KING FAHD UNIVERSITY OF PETROLEUM AND MINERALS, Dhahran (SA)

(72) Inventors: Aasif HELAL, Dhahran (SA); Lolwah Tawfiq ALFUHAID, Dhahran (SA); Galal Atef Ahmed NASSER, Dhahran (SA); Zain H. YAMANI, Dhahran (SA)

(73) Assignee: KING FAHD UNIVERSITY OF PETROLEUM AND MINERALS, Dhahran (SA)

(21) Appl. No.: 18/665,038

(22) Filed: May 15, 2024

(51) Int. Cl. C01B 3/40; B01J 23/745; B01J 23/755; B01J 35/61; B01J 37/02; B01J 37/04; B01J 37/08; B01J 37/18

(52) U.S. Cl. CPC C01B 3/40; B01J 23/745; B01J 23/755; B01J 35/613; B01J 37/0236; B01J 37/04; B01J 37/08; B01J 37/18; C01B 2203/0233; C01B 2203/1058; C01B 2203/1082; C01B 2203/1247; C01B 2203/1614

(57) ABSTRACT

A method for producing hydrogen (H₂) from a dodecane-containing fluid uses a red mud-supported nickel (Ni-SRM) catalyst, where the Ni is present at a concentration of 0.01 to 30 wt. % based on the total weight of the Ni-SRM catalyst to convert dodecane in the dodecane-containing fluid to H₂. The method has a hydrocarbon conversion of at least 85% based on the initial weight of the hydrocarbon present in the dodecane-containing fluid. The H₂ yield using the Ni-SRM catalyst is about 50 to 80% based on the hydrocarbon conversion.

### CROSS REFERENCE TO RELATED APPLICATIONS

Patent application titled “Hydrogen Production via Steam Reforming Over Red Mud Supported Nickel Catalyst and Methods of Preparation Thereof” (attorney docket 552068US) is incorporated herein by reference.

### BACKGROUND

### Technical Field

The present disclosure is directed toward a method for hydrogen (H₂) production, more particularly, H₂ production via steam reformation of dodecane using red mud-supported nickel-based catalysts (Ni-SRM).

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Energy demand has risen rapidly with the rise in technology, economic development, population, and urbanization. Fossil fuels are the primary source for meeting this demand, however resource constraints, varying prices, and serious environmental impact have made it difficult to meet the above-mentioned energy demands (See: Nemitallah, M. A.; Imteyaz. B.; Abdelhafez. A.; Habib, M. A. Experimental and Computational Study on Stability Characteristics of Hydrogen-Enriched Oxy-Methane Premixed Flames). Further, the use of fossil fuels raises the level of carbon dioxide, CO₂, and greenhouse gas (GHG) in the atmosphere, which results in global warming and climate change. Presently, the development of methods and technologies for clean, renewable, and sustainable energy is required. Further, improvement of existing processes or utilization of renewable energy resources will minimize the reliance on fossil fuels, thereby reducing CO₂ emissions, which will promote future energy sustainability and safety worldwide. The renewable energy resources may develop a financially clean and sustainable energy system.

Hydrogen is an alternative to fossil fuels. Hydrogen may meet the global energy demand and reduce CO₂ emissions, thereby reducing global warming (See: Acar, C.; Dincer, I. Review and Evaluation of Hydrogen Production Options for Better Environment). Hydrogen is a sustainable, non-toxic, and clean fuel. Hydrogen as a fuel or energy source may provide carbon-free solutions since its byproduct is only water. Further, hydrogen may act as an energy carrier, a storage medium, and a fuel in different applications (See: Olabi, A. G.; bahri, A. saleh; Abdelghafar, A. A.; Baroutaji, A.; Sayed, E. T.; Alami, A. H.; Rezk, H.; Abdelkareem, M. A. Large-vscale hydrogen production and storage technologies). Hydrogen may be generated from coal gasification, nuclear power, natural gas, renewable energy sources including biomass, solar, wind, and hydro (See: Kadier, A.; Singh, R.; Song, D.; Ghanbari, F.; Zaidi, N. S.; Prihartini Aryanti, P. T.; Jadhav, D. A.; Islam, M. A.; Kalil, M. S.; Nabgan, W.; et al. A Novel Pico-Hydro Power (PHP)-Microbial Electrolysis Cell (MEC) Coupled System for Sustainable Hydrogen Production during Palm Oil Mill Effluent (POME) Wastewater Treatment and Pinsky, R.; Sabharwall, P.; Hartvigsen, J.; O'Brien, J. Comparative Review of Hydrogen Production Technologies for Nuclear Hybrid Energy Systems and Antonini, C.; Treyer, K.; Streb, A.; van der Spek, M.; Bauer, C.; Mazzotti, M. Hydrogen Production from Natural Gas and Biomethane with Carbon Capture and Storage—A Techno-Environmental Analysis).

Traditionally, there are two major approaches to hydrogen production, depending on the raw materials used. The two approaches are a conventional method and the renewable method. Conventional methods use fossil fuels as raw materials, including hydrocarbon reforming, further encompassing steam reforming, partial oxidation, autothermal steam reforming, and hydrocarbon pyrolysis, while renewable methods use sustainable raw materials like biomass and water. Biomass-based methods include thermochemical and biological processes, whereas water-based approaches include water-splitting methods such as electrolysis, thermolysis, and photo-electrolysis (See: Nikolaidis, P.; Poullikkas, A. A Comparative Overview of Hydrogen Production Processes).

Steam reforming technology is presently considered one of the most economical methods to produce hydrogen (See: Zhang, H.; Sun, Z; Hu, Y. H. Steam Reforming of Methane: Current States of Catalyst Design and Process Upgrading). In general, steam reforming (SR) technology is an endothermic process that entails the catalytic transformation of hydrocarbons and steam to hydrogen (H₂) and monoxide (CO). Steam reforming includes primary stages of reforming or synthesis gas (syngas) generation, water-gas shift (WGS), and methanation or gas purification. To refrain from the coke formation on the catalyst surface and produce pure hydrogen (H₂), the steam reforming reaction of n-dodecane should be set at a high temperature, high pressure, and a high steam-to-carbon ratio. A general scheme of steam reforming is provided below:

Hydrocarbon+water↔carbon monoxide+hydrogen

Carbon monoxide+water↔hydrogen+carbon dioxide

Further, to enhance the efficacy of the reaction, a plurality of catalysts may be used to optimize and sustain the steam reforming process. The problems during the reaction such as deactivation of the catalyst, metal sintering, carbon deposition, and sulfur poisoning may be mitigated by catalysts in the steam reforming process (See: Ashok, J.; Das, S.; Dewangan, N.; Kawi, S. Steam Reforming of Surrogate Diesel Model over Hydrotalcite-Derived MO-CaO-Al₂O₃ (M=Ni & Co) Catalysts for SOFC Applications). Even though Nickel (Ni) based catalyst are more cost-effective and enhance the quality of gas products, issues such as carbon deposition and sintering result in the deactivation of the catalyst. As a result, there is an insistent challenge to enhance the stability, catalytic activity, and cost-effectiveness of Ni-based catalysts (See: Li, L; Cheruvathur, A.; Zuo, S.; An, P.; Hou, F.; Xu, J.; Li, G.; Liu, G. Surface Structure Modulating of Ni-Pt Bimetallic Catalysts Boosts n-Dodecane Steam Reforming). Ling Li and coworkers prepared a NiPt/Al₂O₃ catalyst with different surface structures for the steam reforming reaction of n-dodecane (See: Li, L; Cheruvathur, A.; Zuo, S.; An, P.; Hou, F.; Xu, J.; Li, G.; Liu, G. Surface Structure Modulating of Ni-Pt Bimetallic Catalysts Boosts n-Dodecane Steam Reforming). Three different structures are Ni—Pt/Al₂O₃, NiPt/Al₂O₃, and Pt—Ni/Al₂O₃. Bofeng and coworkers synthesized Ni—Pt clusters into silicalite-1 microporous channels and examine its performance in the steam reforming of n-dodecane (SRD) (See: Zhang, B.; Tian, Y.; Chen, D.; Li, L; Li, G.; Wang, L; Zhang, X.; Liu, G. Selective Steam Reforming of N-Dodecane over Stable Subnanometric NiPt Clusters Encapsulated in Silicalite-1 Zeolite). The results showed a full conversion of n-dodecane with an H₂ selectivity of up to 69.9% for three hours. Considering the multitude of studies of the synthesized catalysts currently available for the steam reforming process of n-dodecane, there is still a necessity to develop catalysts that exhibit attributes such as low cost, high efficiency, stability, resistance to coke formation, and enhanced resistance to deactivation for the SRD.

Although a plurality of catalysts for the steam reforming process of hydrocarbons is available presently, the present methods are inefficient, detrimental to the environment, and expensive. Hence, it is one object of the present disclosure to provide a method for hydrogen production using a catalyst with high efficiency and selectivity, that may circumvent the aforementioned drawbacks.

### SUMMARY

In an exemplary embodiment, a method for producing hydrogen (H₂) is described. The method includes introducing a H₂-containing feed gas stream into a reactor containing a red mud-supported nickel (Ni-SRM) catalyst including Ni-SRM catalyst particles. Ni is present in the Ni-SRM catalyst at a concentration of 0.01 to 30 wt. % based on a total weight of the Ni-SRM catalyst. The method further includes passing the H₂-containing feed gas stream through the reactor to contact the H₂-containing feed gas stream with the Ni-SRM catalyst particles at a temperature of 500 to 900 degrees Celsius (° C.) to form a reduced Ni-SRM catalyst. The method further includes terminating the introduction of H₂-containing feed gas stream and simultaneously introducing a hydrocarbon-containing fluid and a water vapor stream into the reactor containing the reduced Ni-SRM catalyst. The method further includes passing the hydrocarbon-containing fluid and the water vapor stream through the reactor to contact the hydrocarbon-containing fluid and the water vapor stream with the reduced Ni-SRM catalyst thereby converting at least a portion of the hydrocarbon to H₂ and producing a residue gas stream leaving the reactor. Finally, the method includes separating the H₂ from the residue gas stream to generate a H₂-containing product gas stream.

In some embodiments, the reactor is at least one selected from a group consisting of a fixed-bed reactor, a trickle-bed reactor, a moving bed reactor, a rotating bed reactor, a fluidized bed reactor, and a slurry reactor.

In some embodiments, the reactor is a fixed-bed reactor in the form of a cylindrical reactor and includes a top portion, a cylindrical body portion, a bottom portion, a housing having an open top and open bottom supportably maintained with the cylindrical body portion. The Ni-SRM catalyst is supportably retained within the housing to permit fluid flow therethrough. At least one propeller agitator is disposed in the bottom portion of the reactor. The bottom portion is cone or pyramidal in shape and a plurality of recirculation tubes fluidly connects the bottom portion of the cylindrical reactor with the cylindrical body portion of the cylindrical reactor.

In some embodiments, the H₂ is present in the H₂-containing feed gas stream at a concentration of 90 volume percentage (vol. %) to 99.99 vol. % based on a total volume of the H₂-containing feed gas stream.

In some embodiments, the hydrocarbon is present in the hydrocarbon-containing fluid at a concentration of 50 to 95 vol. % based on a total volume of the hydrocarbon-containing fluid.

In some embodiments, the hydrocarbon-containing fluid further includes an inert gas selected from a group consisting of nitrogen, argon, and helium.

In some embodiments, the flow rate of the hydrocarbon-containing fluid to the water vapor stream introduced into the reactor is about 8:1 to 1:2.

In some embodiments, the passing of the hydrocarbon-containing fluid and the water vapor stream through the reactor is performed at a temperature of about 700° C.

In some embodiments, the hydrocarbon-containing fluid includes one or more C8 to C25 aliphatic hydrocarbons.

In some embodiments, the hydrocarbon-containing fluid includes dodecane.

In some embodiments, the hydrocarbon-containing fluid is dodecane, and the residue gas stream includes H₂, methane (CH₄), carbon monoxide (CO), carbon dioxide (CO₂) or mixtures thereof.

In some embodiments, the Ni-SRM catalyst is in the form of aggregated Ni particles disposed on porous surfaces of red mud particles.

In some embodiments, the Ni-SRM catalyst has a Brunauer-Emmett-Teller (BET) surface of 5 to 15 cubic meters per gram (m³/g).

In some embodiments, the Ni-SRM catalyst includes hematite (Fe₂O₃), nickel ferrite (NiFe₂O₄), quartzite (SiO₂), calcium silicon oxide (Ca₂SiO₄), calcium aluminum oxide (Ca₃Al₂O₆), aluminum oxide (Al₂O₃), magnetite (Fe₂O₄), hercynite (FeAl₂O₄), nickel (Ni), nickel oxide (NiO), nickel aluminate (NiAl₂O₄) as determined by X-ray diffraction (XRD) analysis.

In some embodiments, the method has a hydrocarbon conversion of at least to 85% based on an initial weight of the hydrocarbon present in the hydrocarbon-containing fluid, and the method has a H₂ yield of 50% to 80% based on the hydrocarbon conversion.

In another exemplary embodiment, a method of preparing the Ni-SRM catalyst is described. The method includes preparing the Ni-SRM catalyst by mixing and heating a red mud material and an acid in water to form a first mixture, adjusting a pH of the first mixture to about 8, and heating to form a red mud material precursor in the first mixture, precipitating the red mud material precursor from the first mixture by cooling and calcining at a temperature of about 800° C. to form a treated red mud material, mixing a nickel salt and the treated red mud material in water to form a second mixture containing a Ni-SRM catalyst precursor, and separating the Ni-SRM catalyst precursor from the second mixture and calcining at a temperature of about 800 to 1200° C. to form the Ni-SRM catalyst. The Ni is present in the Ni-SRM catalyst at a concentration of 10 to 20 wt. % based on a total weight of the Ni-SRM catalyst.

In some embodiments, the acid is at least one selected from a group consisting of hydrochloric acid, nitric acid, sulfuric acid, sulfonic acid, phosphoric acid, or mixtures thereof.

In some embodiments, the method includes adjusting the pH by adding an aqueous solution of ammonia into the first mixture.

In some embodiments, the nickel salt includes nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

In some embodiments, the Ni-SRM catalyst precursor after separating is calcined at a temperature of about 950° C.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart illustrating a method for producing hydrogen (H₂), according to certain embodiments.

FIG. 1B is a flowchart illustrating a method for preparing a red mud-supported nickel-based catalyst (Ni-SRM), according to certain embodiments.

FIG. 2 is a graph showing an X-ray diffraction of various catalysts, according to certain embodiments.

FIG. 3 is a graph showing a Fourier transform infrared (FT-IR) spectra of Ni-based red mud catalysts with different percentages of loaded Ni (0, 10, 15, and 20 wt. %) catalysts, herein designated as 0% Ni@RM, 10% Ni@RM, 15% Ni@RM, and 20% Ni@RM, respectively, according to certain embodiments.

FIG. 4 is a graph showing nitrogen (N₂) adsorption-desorption of 0% Ni@RM, 10% Ni@RM, 15% Ni@RM, and 20% Ni@RM, according to certain embodiments.

FIG. 5A is a scanning electron microscopy (SEM) image showing surface morphology of 0% Ni@RM catalyst, according to certain embodiments.

FIG. 5B shows an energy dispersive X-ray spectroscopy (EDS) mapping analysis of 0% Ni@RM catalyst, according to certain embodiments.

FIG. 5C shows EDS spectra of 0% Ni@RM catalyst, according to certain embodiments.

FIG. 5D is a SEM image of 10% Ni@RM catalyst, according to certain embodiments.

FIG. 5E shows EDS elemental mapping analysis of 10% Ni@RM catalyst, according to certain embodiments.

FIG. 5F shows EDS spectra of 10% Ni@RM catalyst, according to certain embodiments.

FIG. 5G shows SEM image of 15% Ni@RM catalyst, according to certain embodiments.

FIG. 5H shows EDS elemental mapping analysis of 15% Ni@RM catalyst, according to certain embodiments.

FIG. 5I shows EDS spectra of 15% Ni@RM catalyst, according to certain embodiments.

FIG. 5J is a SEM image of 20% Ni@RM catalyst, according to certain embodiments.

FIG. 5K shows EDS elemental mapping analysis of 20% Ni@RM catalyst, according to certain embodiments.

FIG. 5L shows EDS spectra of 20% Ni@RM catalyst, according to certain embodiments.

FIG. 6A is a graph showing steam reforming of n-dodecane (SRD) over 0% Ni@RM catalyst, according to certain embodiments.

FIG. 6B is a graph showing SRD over 10% Ni@RM catalyst, according to certain embodiments.

FIG. 6C is a graph showing SRD over 15% Ni@RM catalyst, according to certain embodiments.

FIG. 6D is a graph showing SRD over 20% Ni@RM catalyst, according to certain embodiments.

FIG. 7A shows yield percentage of various gases—hydrogen (H₂), carbon monoxide (CO), and H₂/CO ratio using 0% Ni@RM catalyst from SRD, according to certain embodiments.

FIG. 7B shows yield percentage of H₂, CO, and H₂/CO ratio using 10% Ni@RM catalyst from the SRD, according to certain embodiments.

FIG. 7C shows yield percentage of H₂, CO, and H₂/CO ratio using 15% Ni@RM catalyst from the SRD, according to certain embodiments.

FIG. 7D shows yield percentage of H₂, CO, and H₂/CO ratio using 20% Ni@RM catalyst from the SRD, according to certain embodiments.

FIG. 8A shows percentage selectivity average of each catalyst for various gases, according to certain embodiments.

FIG. 8B is a graph showing the stability test of 20% Ni@RM catalyst, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all, embodiments of the disclosure are shown.

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the terms “particle size” and “pore size” may be thought of as the lengths or longest dimensions of a particle and of a pore opening, respectively.

As used herein, the term “ultrasonication” or “sonication” refers to the process in which sound waves are used to agitate particles in a solution.

As used herein the term “deionized water” refers to the water that has (most of) the ions removed.

As used herein, the term “calcination” refers to heating a compound to a high temperature, under a restricted supply of ambient oxygen. This is performed to remove impurities or volatile substances and to incur thermal decomposition.

As used herein, the term “thermal decomposition (or thermolysis)” refers to a chemical decomposition initiated by heat. The decomposition temperature is the temperature at which a substance undergoes chemical decomposition.

As used herein, the term ‘temperature-programmed reduction (TPR)’ refers to a technique for characterizing solid materials.

As used herein, the term “aspect ratio” refers to the ratio of length to width of cylinder.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

The present disclosure is intended to include all isotopes of a given compound or formula, unless otherwise noted. Isotopes include those atoms having the same atomic number but different mass numbers. By way of general example, and without limitation, isotopes of hydrogen include deuterium and tritium. Isotopes of naturally occurring nickel ²⁸Ni include ⁵⁸Ni, ⁶⁰Ni, ⁶¹Ni, ⁶²Ni, and ⁶⁴Ni. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed towards hydrogen production via steam reforming of a hydrocarbon such as n-dodecane (SRD) using Ni-based red mud catalysts with varying percentages of loaded Ni. This approach provides a sustainable way to produce hydrogen with enhanced efficiency and stability.

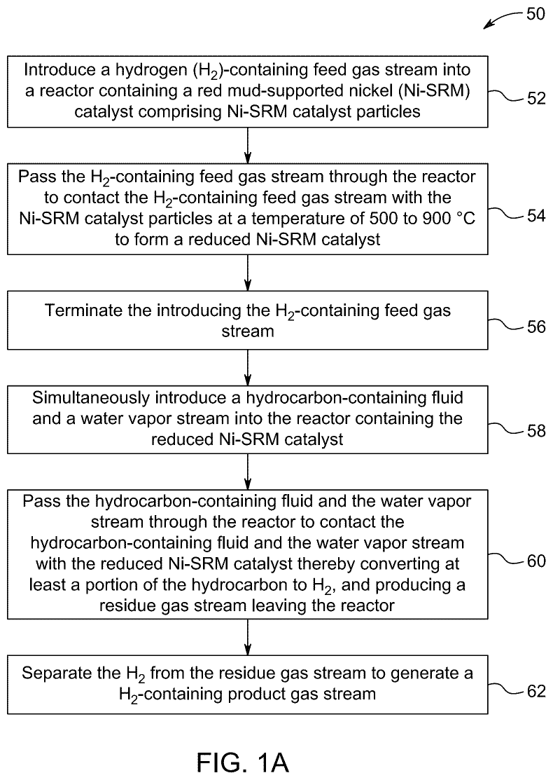

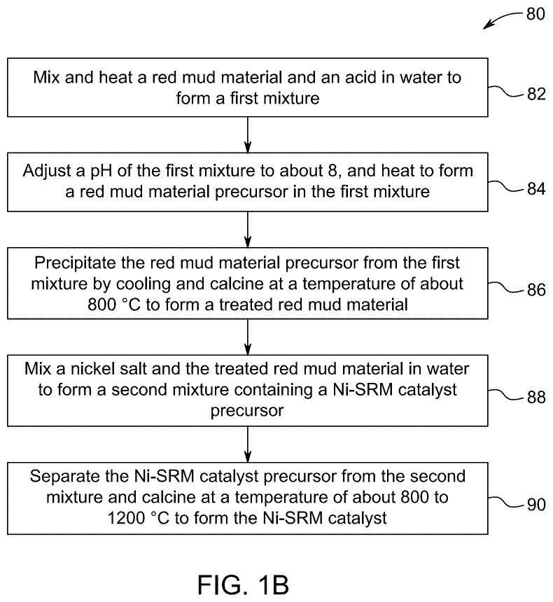

FIG. 1A illustrates a flow chart of a method 50 for producing hydrogen (H₂). The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes introducing a H₂-containing feed gas stream into a reactor containing a red mud supported nickel (Ni-SRM) catalyst including Ni-SRM catalyst particles. In some embodiments, the H₂ is present in the H₂-containing feed gas stream at a concentration of 90-99.99 vol. %, preferably 90.5-99.5 vol. %, preferably 91-99 vol. %, preferably 91.5-98.5 vol. %, preferably 92-98 vol. %, preferably 92.5-97.5 vol. %, preferably 93-97 vol. %, preferably 93.5-96.5 vol. %, preferably 94-96 vol. %, preferably 94.5-95.5 vol. %, based on the total volume of the H₂-containing feed gas stream.

In some embodiments, the reactor is at least one selected from the group consisting of a fixed-bed reactor, a trickle-bed reactor, a moving bed reactor, a rotating bed reactor, a fluidized bed reactor, and a slurry reactor. In a preferred embodiment, the reactor is a fixed-bed quartz reactor. In an embodiment, the reactor is the fixed-bed reactor in the form of a cylindrical reactor including a top portion, a cylindrical body portion, a bottom portion, and a housing having an open top and open bottom supportably maintained with the cylindrical body portion. In some embodiments, the Ni-SRM is supportably retained within the housing permitting fluid flow therethrough. In some embodiments, the bottom portion is cone-shaped or pyramidal. In some embodiments, at least one propeller agitator is disposed of in the bottom portion of the reactor. In some embodiments, a plurality of recirculation tubes fluidly connects the bottom portion of the cylindrical reactor with the cylindrical body portion of the cylindrical reactor. In some embodiments, at least one propeller agitator disposed in the bottom portion of the reactor.

At step 54, the method 50 includes passing the H₂-containing feed gas stream through the reactor to contact the H₂-containing feed gas stream with the Ni-SRM catalyst particles at a temperature of 500-900 degrees Celsius (° C.), preferably 510-890° C., preferably 520-880° C., preferably 530-870° C., preferably 540-860° C., preferably 550-850° C., preferably 560-840° C., preferably 570-830° C., preferably 580-820° C., preferably 590-810° C., preferably 600-800° C., preferably 610-790° C., preferably 620-780° C., preferably 630-770° C., preferably 640-760° C., preferably 650-750° C., preferably 660-740° C., preferably 670-730° C., preferably 680-720° C., and preferably 690-710° C., to form an activated Ni-SRM catalyst. In a preferred embodiment, the H₂-containing feed gas stream is passed through the reactor to contact the H₂-containing feed gas stream with particles of the catalyst at a temperature of 750° C. to form a reduced catalyst.

At step 56, the method 50 includes terminating the introducing the H₂-containing feed gas stream. Subsequently, the reactor temperature is set to the targeted study condition under a continuous flow of an inert gas, preferably nitrogen, preferably argon, and more preferably helium. In a preferred embodiment, the reactor temperature is subsequently set to the targeted study condition under a continuous flow of nitrogen.

At step 58, the method 50 includes simultaneously introducing a hydrocarbon-containing fluid and a water vapor stream into the reactor containing the reduced Ni-SRM catalyst.

At step 60, the method 50 includes passing the hydrocarbon-containing fluid and the water vapor stream through the reactor to contact the hydrocarbon-containing fluid and the water vapor stream with the reduced Ni-SRM catalyst thereby converting at least a portion of the hydrocarbon to H₂ and producing a residue gas stream leaving the reactor. In a preferred embodiment, the passing of the hydrocarbon-containing fluid and the water vapor stream through the reactor is performed at a temperature of about 600-800° C., preferably 610-790° C., preferably 620-780° C., preferably 630-770° C., preferably 640-760° C., and preferably 650-750° C. In a preferred embodiment, the passing of the hydrocarbon-containing fluid and the water vapor stream through the reactor is performed at a temperature of about 700° C.

In some embodiments, hydrocarbon is present in the hydrocarbon-containing fluid, liquid and/or gaseous, at a concentration of 50-95 vol. %, preferably 55-90 vol. %, preferably 60-85 vol. %, preferably 65-80 vol. %, and preferably 70-75 vol. %, based on a total volume of the hydrocarbon-containing fluid. In some embodiments, the hydrocarbon-containing fluid further includes an inert gas selected from the group consisting of nitrogen, argon, and helium. In a preferred embodiment, the hydrocarbon-containing fluid further includes nitrogen gas as the inert gas. In some embodiments, a flow rate of the hydrocarbon-containing fluid to the water vapor stream introduced into the reactor is about 8:1 to 1:2, preferably 7:1 to 1:3, preferably 6:1 to 1:4, preferably 5:1 to 1:5. In a preferred embodiment, a flow rate of the hydrocarbon-containing fluid to the water vapor stream introduced into the reactor is about 1:2.

The hydrocarbon-containing fluid comprises one or more C8 to C25 aliphatic hydrocarbons. The C8 to C25 aliphatic hydrocarbons may include one or more of octane, octene, octyne, nonane, nonene, nonyne, decane, decene, decyne, undecane, undecene, undecyne, dodecane, dodecene, dodecyne, tridecane, tridecene, tridecyne, tetradecane, tetradecene, tetradecyne, pentadecane, pentadecene, pentadecyne, hexadecane, hexadecene, hexadecyne, heptadecane, heptadecene, heptadecyne, octadecane, octadecene, octadecyne nonadecane, nonadecene, nonadecyne, icosane, henicosane, docosane, tricosane, tetracosane, pentacosane or mixtures thereof. In a preferred embodiment, the hydrocarbon-containing fluid is dodecane, preferably n-dodecane. In some embodiments, the residue gas stream comprises H₂, methane, CO, CO₂, or mixtures thereof.

In some embodiments, the method has a hydrocarbon conversion of at least up to 85%, preferably 90%, preferably 95%, based on an initial weight of the hydrocarbon present in the hydrocarbon-containing fluid. In some embodiments, the method has a H₂ yield of 50-80%, preferably 51-79%, preferably 52-78%, preferably 53-77%, preferably 54-76%, preferably 55-75%, preferably 56-74%, preferably 57-73%, preferably 58-72%, preferably 59-71%, preferably 60-70%, preferably 61-69%, preferably 62-68%, preferably 63-67%, and preferably 64-66%, based on the hydrocarbon conversion. In a preferred embodiment, the method has a H₂ yield of up to 72.96%, based on the hydrocarbon conversion.

At step 62, the method 50 includes separating the H₂ from the residue gas stream to generate a H₂-containing product gas stream. The H₂ may be separated from the residue gas stream by any of the techniques known in the art.

FIG. 1B illustrates a flow chart of a method 80 for preparing the Ni-SRM catalyst. The order in which the method 80 is described is not intended to be construed as a limitation, and any number of the described method steps can be combined in any order to implement the method 80. Additionally, individual steps may be removed or skipped from the method 80 without departing from the spirit and scope of the present disclosure.

At step 82, the method 80 includes mixing and heating a red mud material and an acid in water to form a first mixture. Red mud is a low cost, easily available natural industrial waste (See: Ma, S.; Cheng, F.; Meng, J.; Ge, H.; Lu, P.; Song, T. Ni-Enhanced Red Mud Oxygen Carrier for Chemical Looping Steam Methane Reforming). Red mud is a solid bulky waste generated through alumina industrial production. The chemical composition of red mud includes a mixture of hematite (Fe₂O₃), aluminum oxide (Al₂O₃), quartzite (SiO₂), Titanium dioxide (TiO₂), calcium oxide (CaO), and a specific amount of sodium (Na). All these oxides may act as supporter and active oxides (See: Liu, X.; Yang, X.; Liu, C.; Chen, P.; Yue, X.; Zhang, S. Low-Temperature Catalytic Steam Reforming of Toluene over Activated Carbon Supported Nickel Catalysts, incorporated herein by reference in its entirety). The stability and resistance to sintering and poisoning made red mud a good carrier for catalyst, thereby enhancing the gasification activity and increasing the hydrogen yield (See: Zhao, A.; Lv, J.; Chen, Q.; Xie, Y.; Cao, Y.; Jiang, C.; Ao, X. Spirit-Based Distillers' Grains and Red Mud Synergistically Catalyse the Steam Gasification of Anthracite to Produce Hydrogen-Rich Synthesis Gas). The acid is at least one selected from the group consisting of hydrochloric acid, nitric acid, sulfuric acid, sulfonic acid, phosphoric acid, or mixtures thereof. In a preferred embodiment, the acid is hydrochloric acid (HCl). The water may be tap water, distilled water, bidistilled water, deionized water, deionized distilled water, reverse osmosis water, and/or some other water. In a preferred embodiment, the solvent is deionized water. The mixing may be carried out manually or with the help of a stirrer. The heating can be done by using heating appliances such as hot plates, heating mantles, hot air ovens, microwaves, autoclaves, tapes, oil baths, salt baths, sand baths, air baths, hot-tube furnaces, and hot-air guns.

At step 84, the method 80 includes adjusting a pH of the first mixture to about 8, and heating to form a red mud material precursor in the first mixture. The pH may be adjusted by adding any base like potassium hydroxide (KOH), sodium hydroxide (NaOH), calcium hydroxide (Ca(OH)₂), potassium carbonate (K₂CO₃), ammonia (NH₃), or mixtures thereof. In a preferred embodiment, the adjusting of the pH is performed by adding an aqueous solution containing ammonia into the first mixture. The heating can be done by using heating appliances such as hot plates, heating mantles, hot air ovens, microwaves, autoclaves, tapes, oil baths, salt baths, sand baths, air baths, hot-tube furnaces, and hot-air guns.

At step 86, the method 80 may include precipitating the red mud material precursor from the first mixture by cooling and calcining at a temperature of about 600-900° C. to form a treated red mud material. The precipitate may be separated from the reaction mixture by methods including, but not limited to, filtration, decantation, and evaporation. The calcination of the material is carried out by heating it to a high temperature, under a restricted supply of ambient oxygen. This is performed to remove impurities or volatile substances and to incur thermal decomposition. Typically, the calcination is carried out in a furnace preferably equipped with a temperature control system, which may provide a heating rate of up to 50° C./min, preferably up to 40° C./min, preferably up to 30° C./min, preferably up to 20° C./min, preferably up to 10° C./min, preferably up to 5° C./min, preferably up to 2° C./min, and preferably up to 1° C./min. In some embodiments, the reaction mixture is calcined at a temperature of 600-900° C., preferably 610-890° C., preferably 620-880° C., preferably 630-870° C., preferably 640-860° C., preferably 650-850° C., preferably 660-840° C., preferably 670-830° C., preferably 680-820° C., preferably 690-810° C., preferably 700-800° C., preferably 710-790° C., preferably 720-780° C., preferably 730-770° C., and preferably 740-760° C. In a preferred embodiment, the method includes precipitating the red mud material precursor from the first mixture by cooling and calcining at a temperature of about 800° C. to form a treated red mud material.

At step 88, the method 80 includes mixing a nickel salt and the treated red mud material in water to form a second mixture containing a Ni-SRM catalyst precursor. In some embodiments, the nickel salt comprises nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate. In a preferred embodiment, the nickel salt is nickel nitrate [Ni(NO₃)₂·6H₂O]. The water may be tap water, distilled water, bidistilled water, deionized water, deionized distilled water, reverse osmosis water, and/or some other water. In a preferred embodiment, the water is deionized water. The mixing may be carried out manually, with the help of a stirrer, or via ultrasonication.

At step 90, the method 80 includes separating the Ni-SRM catalyst precursor from the second mixture and calcining at a temperature of about 800-1200° C., preferably 850-1150° C., preferably 900-1100° C., and preferably 950-1050° C. to form the Ni-SRM catalyst. In a preferred embodiment, the Ni-SRM catalyst precursor, after the separation, is calcined at a temperature of about 950° C.

In some embodiments, Ni is present in the Ni-SRM catalyst at a concentration of 0.01-30 wt. %, preferably 0.5-29.5 wt. %, preferably 1-29 wt. %, preferably 2-28 wt. %, preferably 3-27 wt. %, preferably 4-26 wt. %, preferably 5-25 wt. %, preferably 6-24 wt. %, preferably 7-23 wt. %, preferably 8-22 wt. %, preferably 9-21 wt. %, preferably 10-20 wt. %, preferably 11-19 wt. %, preferably 12-18 wt. %, preferably 13-17 wt. %, preferably 14-16 wt. %, based on a total weight of the Ni-SRM catalyst. In some embodiments, the Ni is present in the Ni-SRM catalyst at a concentration of 10-20 wt. %, preferably 11-19 wt. %, preferably 12-18 wt. %, preferably 13-17 wt. %, preferably 14-16 wt. %, based on the total weight of the Ni-SRM catalyst.

In some embodiments, the Ni-SRM catalyst comprises Fe₂O₃, NiFe₂O₄, SiO₂, Ca₂SiO₄, Ca₃Al₂O₆, Al₂O₃, Fe₂O₄, FeAl₂O₄, Ni, NiO, NiAl₂O₄, as determined by X-ray diffraction (XRD) analysis. In some embodiments, the Ni-SRM catalyst is in the form of aggregated Ni particles disposed on porous surfaces of red mud particles. Pores may be micropores, mesopores, macropores, and/or a combination thereof. The Ni-SRM catalyst has a Brunauer-Emmett-Teller (BET) surface of from 5-15 cubic meters per gram (m³/g), preferably 6-14 m³/g, preferably 7-13 m³/g, preferably 8-12 m³/g, and preferably 9-11 m³/g.

### EXAMPLES

The following examples demonstrate hydrogen production from a hydrocarbon-containing fluid and water vapor in the presence of a red mud-supported nickel (Ni-SRM) catalyst. The examples are provided solely for illustration and are not to be construed as limitations of the present disclosure, as many variations thereof are possible without departing from the spirit and scope of the present disclosure.

### Example 1: Red Mud Treatment

10 grams (g) of red mud and 190 milliliters (mL) of deionized (DI) water were mixed to prepare a red mud slurry and 18 mL of hydrochloric acid (HCl) was added to the slurry. The slurry was further diluted with DI water until a total volume of 800 mL was reached. The slurry is then boiled for 20 minutes (min) at 30 degrees Celsius (° C.). A quantity of ammonia was added to the slurry to achieve a fixed pH of 8, and the temperature was increased to 50° C. and boiled for 10 minutes to form a mixture. The mixture was filtered under the vacuum and washed three times with DI water at 40° C. The filtered mixture was dried in an oven at 120° C. overnight and calcinated at 800° C. for 2 hours (h).

### Example 2: Synthesis of Nickel-Based Red Mud Catalyst (n % Ni@RM)

The wet impregnation method was used to prepare an % Ni@RM catalyst. A quantity of nickel nitrate hexahydrate (Ni(NO₃)₂·6H₂O) needed to provide the appropriate was dissolved in 30 mL of DI water to form a solution and then red mud (RM) was added to the solution. Further, the solution was stirred for 12 h at room temperature. The impregnated Ni-RM catalyst was dried at 120° C. in an oven, crushed into a powder, and calcinated on muffle furnace under nitrogen (N₂) at 950° C. for 3 h. Ni-based red mud catalysts with different percentages of loaded Ni: 0% Ni@RM, 10% Ni@RM, 15% Ni@RM, and 20% Ni@RM were prepared.

### Example 3: Characterization of Ni-Based Red Mud Catalyst (n % Ni@RM)

One or more techniques were used to characterize an % Ni@RM catalyst. Powdered X-ray diffraction (XRD) analysis of the above-mentioned catalyst was performed using a Rigaku MiniFlex diffractometer equipped with copper K-alpha (Cu-Kα) radiation, and data was obtained at 2θ range of 3° to 80°. Fourier transform infrared spectroscopy (FT-IR) of catalyst was acquired using a Nicolet 6700 Thermo Scientific instrument in the range of 400 (per centimeter) cm⁻¹ to 4000 cm⁻¹ with potassium bromide (KBr). The composition of the catalyst was found out using inductively coupled plasma (ICP). The surface morphology of the catalyst was carried out using a field emission scanning electron microscope (FESEM) (FESEM, LYRA 3 Dual Beam, Tescan) operating at 30 kilovolts (kV). The FESEM samples were prepared from suspension in ethanol. The specific surface area of the catalyst was measured by Brunauer Emmett Teller (BET) analysis using Micromeritics ASAP 2020 instrument.

### Example 4: Steam Reforming of n-Dodecane

The steam reforming of the n-dodecane (SRD) reaction was performed at 700° C. in a fixed-bed quartz reactor with an internal diameter (i.d.) of 4 millimeters (mm) and a length (L) of 400 mm. The reactor was loaded with 20 milligrams (mg) of the catalyst, a ratio (S/C) of steam (S) to carbon (C) was maintained at 2, and n-dodecane was fed at the rate of 88.06 micromoles per minute (μmol/min). To begin the catalytic reaction, all the catalyst was reduced to H₂ for 60 min (30 mL/min) at 750° C. To compress the unreacted water, n-dodecane as well as the liquid hydrocarbon product from the reforming process, the byproduct of the reaction was passed through a cold trap which was kept at of 5° C. temperature. Non-condensable gas products were evaluated with the help of carboxen column and thermal conductivity detector (TCD) equipped gas chromatography. The following formula was used to calculate the carbon conversion, which was then used for expressing the n-dodecane conversion.

$${x}_{dodecane} ( \% ) = \frac{( {n}_{CO} + {n}_{CH 4} + {n}_{CO 2} ) \times 100}{12 \times {n}_{r in}}$$

where n is the molar flow rate of each gas.

### Results and Discussion

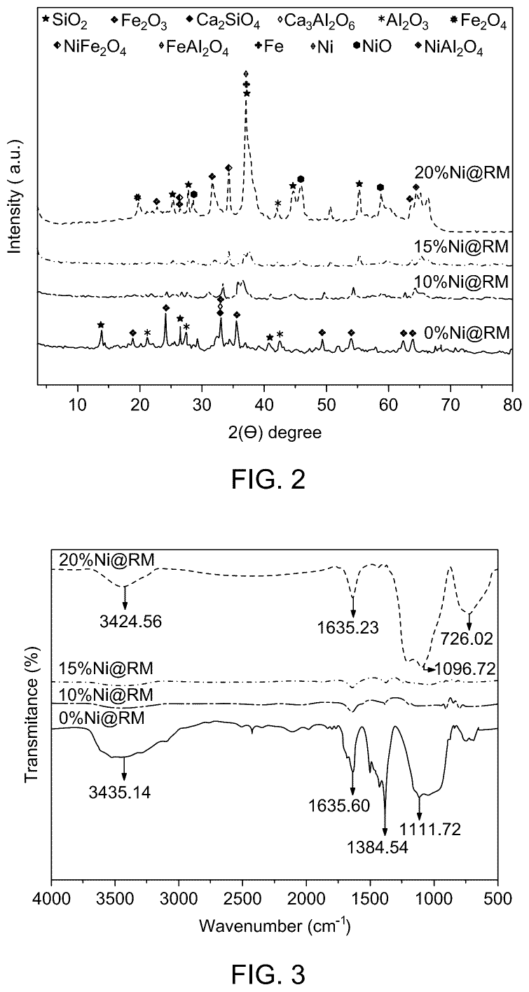

The XRD patterns of the prepared catalyst with different percentages of Ni metal loaded on red mud (RM) are depicted in FIG. 2. The 0% Ni@RM catalyst has a complex composition of metal oxides, viz. quartzite (SiO₂), hematite (Fe₂O₃), calcium silicon oxide (Ca₂SiO₄), calcium aluminum oxide (Ca₃Al₂O₆), and aluminum oxide (Al₂O₃). When the Ni amount is augmented, two new peaks of metallic iron (Fe) at (2θ=37.02) and magnetite (Fe₂O₄) at (2θ=19.89) are observed. Further, interactions between Ni, Al, and Fe may cause the appearance of peaks that correspond to a cubic spinel structure of NiFe₂O₄ at (2θ=34.32), and NiAl₂O₄ at (2θ=64.62). Furthermore, the NiO peak at (2θ=58.84) is intensified with an increasing amount of Ni in the catalyst. Table 1 shows the main combination of the catalysts in terms of majority components such as Al, Fe, and Ni. As noted in Table 1, 0% Ni@RM catalyst includes a major amount of hematite (Fe₂O₃) and aluminum oxide (Al₂O₃).

FIG. 3 shows a Fourier transform infrared (FT-IR) spectra of Ni-based red mud catalysts with different percentages of loaded Ni: 0% Ni@RM, 10% Ni@RM, 15% Ni@RM, and 20% Ni@RM catalyst.

TABLE 1
Elements composition of catalysts samples from inductively coupled
plasma optical emission spectroscopy (ICP-OES) analysis.

| Sample | Al (ppm) | Fe (ppm) | Ni(ppm) |
|---|---|---|---|
| 0% Ni@RM | 79773.9 | 64773.2 | — |
| 10% Ni@RM | 63735.1 | 10638.4 | 4655.3 |
| 15% Ni@RM | 8341.0 | 12911.4 | 1811.0 |
| 20% Ni@RM | 6173.1 | 8946.0 | 19060.8 |

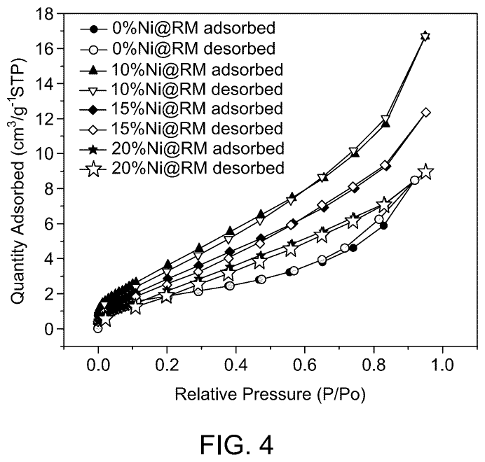

FIG. 4. shows N₂ adsorption-desorption isotherms of the catalyst. The mesoporous properties of the catalysts are confirmed as all the catalysts exhibit IV-type isotherms. Table 2 shows the BET surface area of different catalysts: 0% Ni@RM, 10% Ni@RM, 15% Ni@RM, and 20% Ni@RM. As can be seen from Table 2, the BET surface area (S_{BET}) of the catalysts decreases with an increased amount of Ni.

TABLE 2
BET surface area of 0% Ni@RM, 10% Ni@RM,
15% Ni@RM, and 20% Ni@RM.

| Sample | S_{BET} cubic meter per gram (m³/g) |
|---|---|
| 0% Ni@RM | 149.44 |
| 10% Ni@RM | 13.22 |
| 15% Ni@RM | 10.39 |
| 20% Ni@RM | 8.12 |

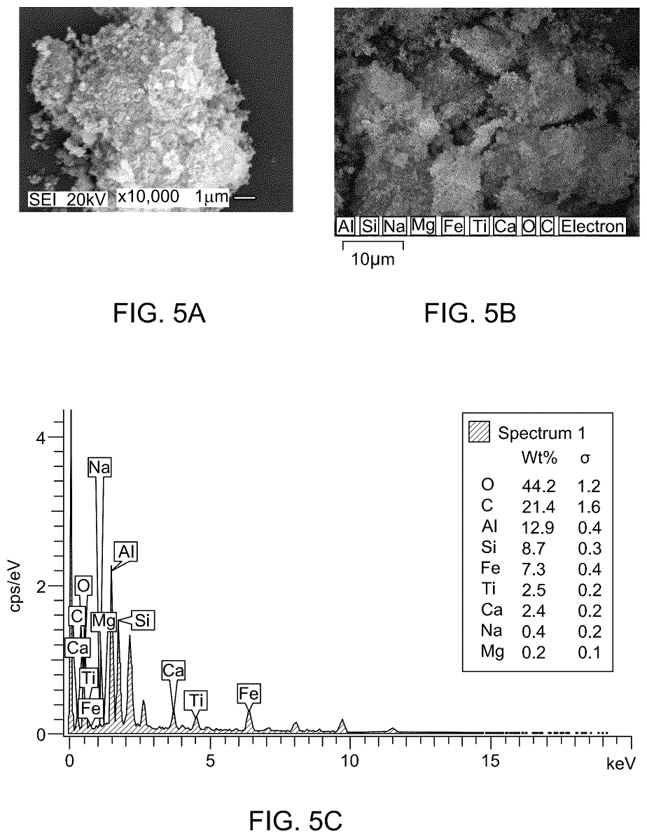

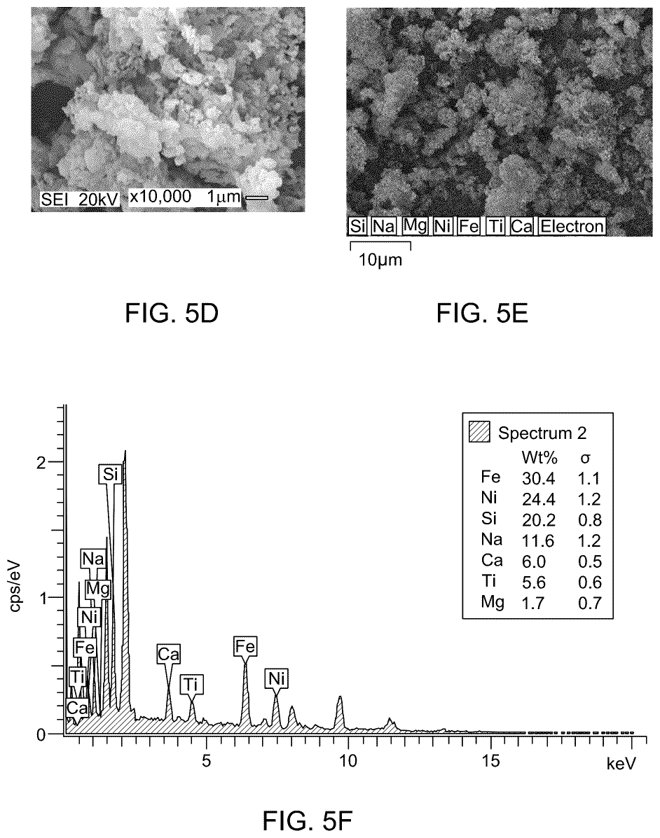

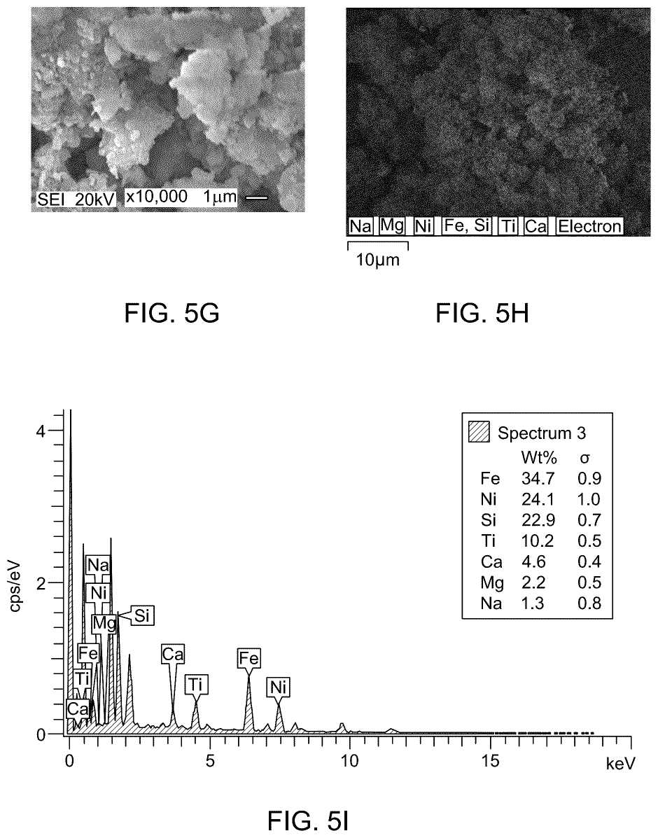

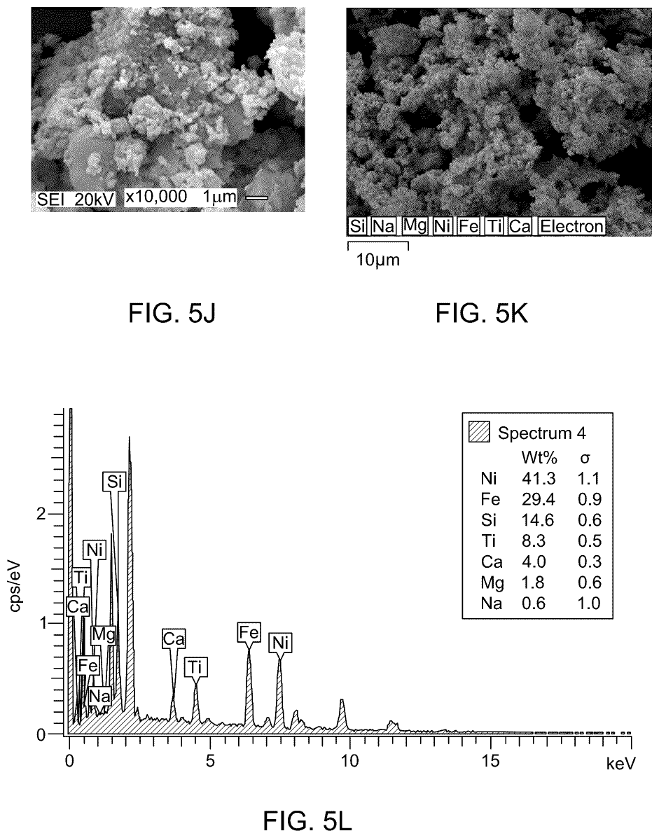

FIG. 5A, FIG. 5D, FIG. 5G, and FIG. 5J shows SEM images of 0% Ni@RM, 10% Ni@RM, 15% Ni@RM, and 20% Ni@RM catalysts, respectively. A dense and less porous surface of 0% Ni@RM catalyst. The surface morphology changes when the Ni % is increased by wet impregnation method. As in the cases of the 10% Ni@RM, 15% Ni@RM, and 20% Ni@RM catalysts, small particles are seen scattered, and the surface appears uneven and porous. FIG. 5B, FIG. 5E, FIG. 5H, and FIG. 5K shows EDS elemental mapping analysis of 0% Ni@RM, 10% Ni@RM, 15% Ni@RM, and 20% Ni@RM catalysts, respectively. FIG. 5C, FIG. 5F, FIG. 5I, and FIG. 5L shows EDS sprectra of 0% Ni@RM, 10% Ni@RM, 15% Ni@RM, and 20% Ni@RM catalysts, respectively.

The XRD results confirmed that the uneven and porous surface of the catalysts is due to the formation of NiO, NiFe₂O₄, and NiAl₂O₄ as Ni elements get loaded on the RM and change the surface of RM. Further, the appearance of a new peak in the SEM results confirms that the Ni element is loaded on the catalyst surface.

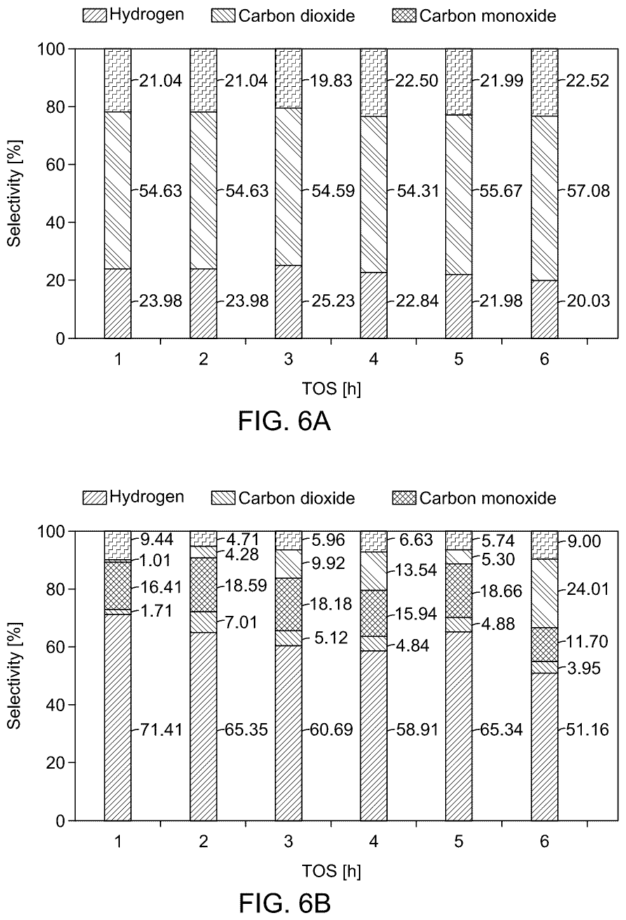

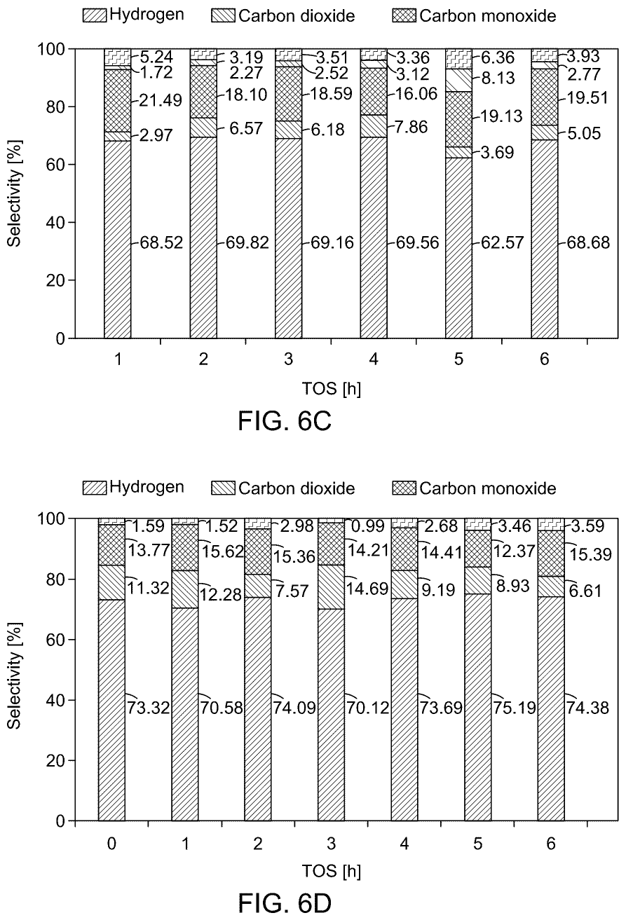

Hydrogen production from steam reforming reaction of n-dodecane with 0% Ni@RM, 10% Ni@RM, 15% Ni@RM, and 20% Ni@RM is performed at a temperature of 700° C. under S/C ratio 2. The gaseous products in the SRD reaction were methane (CH₄), carbon dioxide (CO₂), carbon monoxide (CO), and hydrogen (H₂). FIGS. 6A-6D illustrates the performance of each catalyst during the SRD reaction. As can be seen from FIG. 6A the selectivity of hydrogen production of 0% Ni@RM catalyst decreased from 24% to 20%, while the selectivity of C²⁺ and CH₄ increases such as from 54.36% to 57.08% for C²⁺ and from 21.04 to 22.52% for CH₄. The decrease in selectivity may have occurred due to the deactivation performance, sintering, and coking of the catalyst. As can be seen from FIG. 6B, efficacy of 10% Ni@RM, is increased in hydrogen selectivity in contrast to 0% Ni@RM catalyst. Initially, H₂ selectivity is 71.4%, however later on the H₂ selectivity decreases to 51.2%. Further, the selectivity of the resulting gases C²⁺, CH₄, CO₂, and CO are decreased. This shows the effectiveness and efficiency of the catalyst when red mud is enhanced with Ni metal. As can be seen from FIG. 6C, the 15% Ni@RM has lower hydrogen selectivity compared to 10% Ni@RM. Further, SEM and EDS results may indicate that the lowering hydrogen selectivity is due to the porosity and distribution of Ni ions on the RM surface, causing agglomeration and sintering FIG. 6D shows the highest hydrogen selectivity in the case of 20% Ni@RM. This is due to the presence of a plurality of active sites and an efficiency of 20% Ni@RM. Further, 20% Ni@RM catalyst has the lowest selectivity of CH₄, CO₂, and CO.

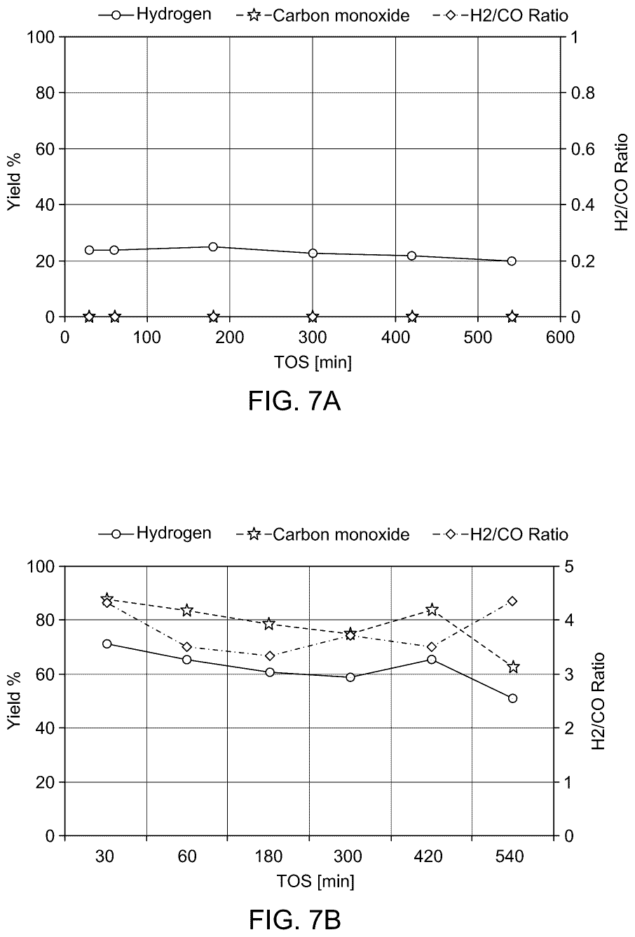

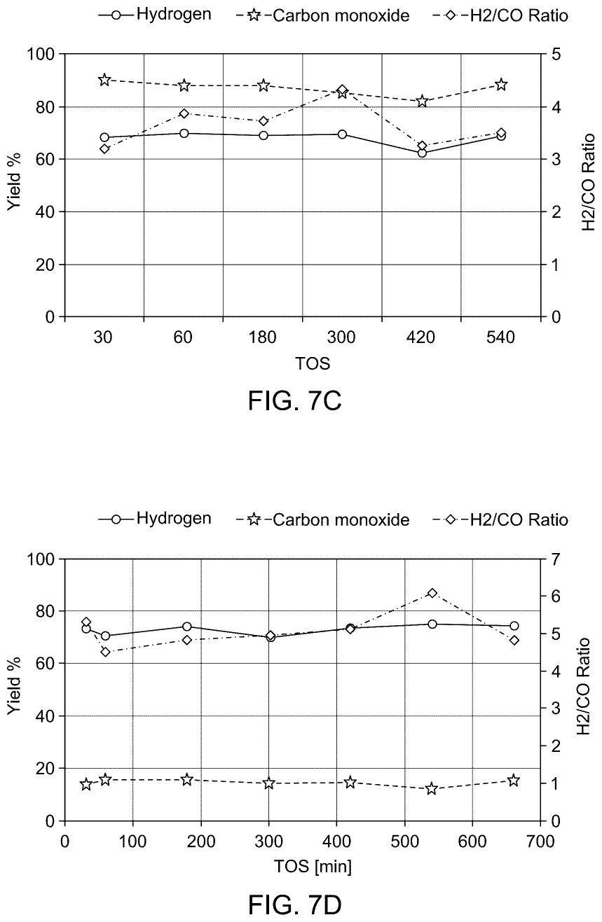

Furthermore, FIGS. 7A-7D illustrates the yield percentages of H₂, CO, and the H₂/CO ratio for 0% Ni@RM, 10% Ni@RM, 15% Ni@RM, and 20% Ni@RM catalysts, respectively implemented in the SRD reaction. As can be seen from FIGS. 7A-7D, the 0% Ni@RM has the lowest H₂, CO, and H₂/CO ratio thereby making it an ineffective catalyst in the SRD reaction. In contrast, the 20% Ni@RM shows the highest H₂ and CO percentage and highest H₂/CO ratio, thereby being an effective catalyst in the water-gas shift reaction.

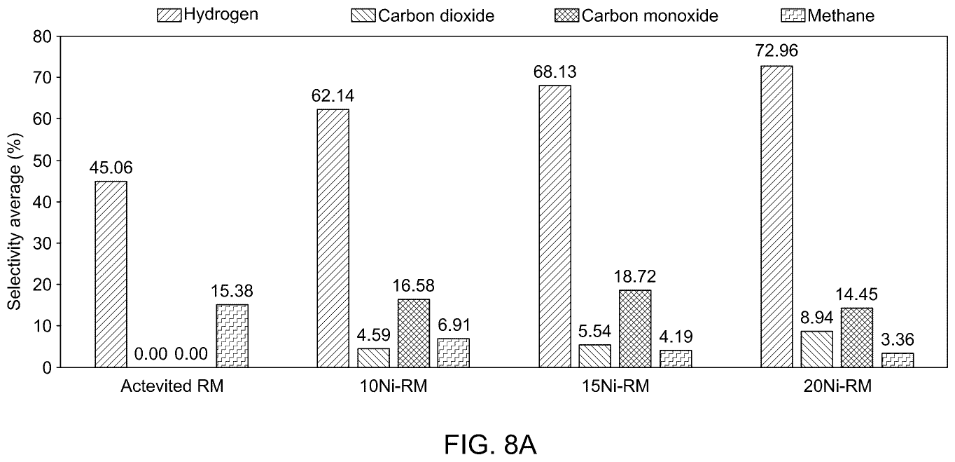

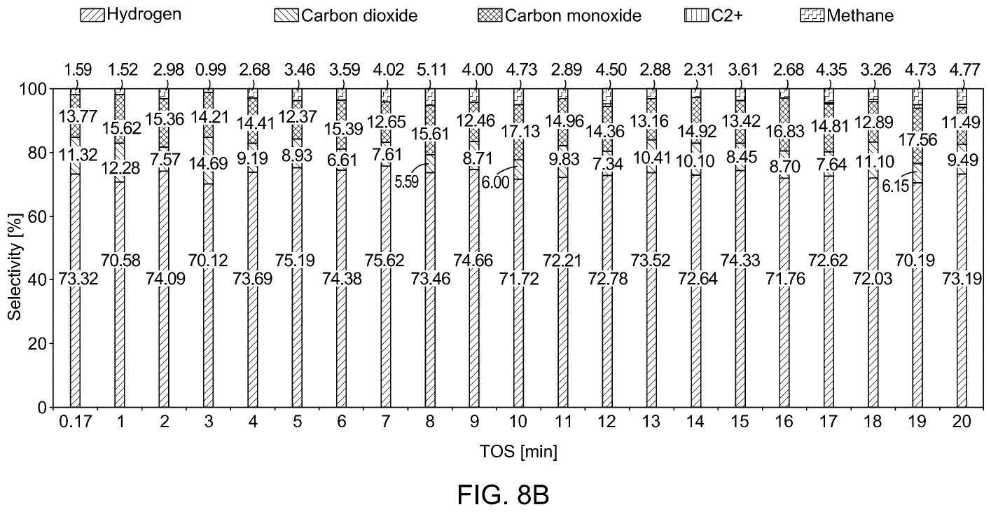

FIG. 8A is a graph showing the selectivity average of each catalyst and FIG. 8B is a graph showing the stability test of 20% Ni@RM catalyst. Following the results, the 20% Ni@RM catalyst exhibited superior selectivity of H₂ and efficient conversion of n-dodecane. To evaluate the stability of catalyst performance, the 20% Ni@RM catalyst was exposed to extended testing hours at 700° C. In the stability test of the 20% Ni@RM, the catalyst in the SRD reaction demonstrated a slight performance decay of the catalyst within the testing hours, which means the 20% Ni@RM catalyst has excellent stability performance making it a promising candidate for sustainable and prolonging performance in the SRD reaction.

Ni-based red mud catalysts with different percentages of loaded Ni, for use in hydrogen production by steam reforming of dodecane are described. The FTIR spectra, the SEM, and EDS maps of the catalysts are described. Further, the steam reforming of n-dodecane, and the yield percentage of H₂, CO, and H₂/CO ratio of these catalysts were determined. The 20% Ni@RM catalyst is superior in terms of selectivity of H₂ and efficient conversion of n-dodecane. The catalyst, as described in the present disclosure, may provide an economical, sustainable, and efficient method to produce hydrogen to be used as a green fuel.

Numerous modifications and variations of the present disclosure are possible in light of the above teachings. It is therefore to be understood that within the scope of the appended claims, the invention may be practiced otherwise than as specifically described herein.

1: A method for producing hydrogen (H₂) from dodecane, comprising:
preparing an Ni-SRM catalyst by:
mixing and heating a red mud material and an acid in water to form a first mixture;
mixing ammonia with the first mixture until a pH of the first mixture is about 8, then heating and drying to form a red mud material precursor;
calcining the red mud material precursor at a temperature of about 800° C. to form a treated red mud material;
mixing a nickel salt and the treated red mud material in water to form a second mixture containing a Ni-SRM catalyst precursor;
separating the Ni-SRM catalyst precursor from the second mixture; and
calcining at a temperature of 800 to 1200° C. to form the Ni-SRM catalyst comprising Ni-SRM catalyst particles;
wherein the Ni is present in the Ni-SRM catalyst at a concentration of 10 to 20 wt. % based on a total weight of the Ni-SRM catalyst; then
introducing a H₂-containing feed gas stream into a reactor containing the Ni-SRM catalyst;
passing the H₂-containing feed gas stream through the reactor to contact the H₂-containing feed gas stream with the Ni-SRM catalyst particles at a temperature of 500 to 900° C. to form a reduced Ni-SRM catalyst;
terminating the introducing the H₂-containing feed gas stream;
simultaneously introducing a dodecane-containing fluid and a water vapor stream into the reactor containing the reduced Ni-SRM catalyst;
passing the dodecane-containing fluid and the water vapor stream through the reactor to contact the dodecane-containing fluid and the water vapor stream with the reduced Ni-SRM catalyst thereby converting at least a portion of the dodecane to H₂, and producing a residue gas stream leaving the reactor; and
separating the H₂ from the residue gas stream to generate a H₂-containing product gas stream.

2: The method of claim 1, wherein the reactor is at least one selected from a group consisting of a fixed-bed reactor, a trickle-bed reactor, a moving bed reactor, a rotating bed reactor, a fluidized bed reactor, and a slurry reactor.

3: The method of claim 1, wherein the reactor is a fixed-bed reactor in the form of a cylindrical reactor comprising:
a top portion;
a cylindrical body portion;
a bottom portion;
a housing having an open top and open bottom supportably maintained with the cylindrical body portion;
wherein the Ni-SRM catalyst is supportably retained within the housing permitting fluid flow therethrough;
at least one propeller agitator is disposed in the bottom portion of the reactor;
wherein the bottom portion is cone shaped or pyramidal; and
wherein a plurality of recirculation tubes fluidly connects the bottom portion of the cylindrical reactor with the cylindrical body portion of the cylindrical reactor.

4: The method of claim 1, wherein the H₂ is present in the H₂-containing feed gas stream at a concentration of 90 to 99.99 vol. % based on a total volume of the H₂-containing feed gas stream.

5: The method of claim 1, wherein the dodecane is present in the dodecane-containing fluid at a concentration of 50 to 95 vol. % based on a total volume of the dodecane-containing fluid.

6: The method of claim 1, wherein the dodecane-containing fluid further comprises an inert gas selected from a group consisting of nitrogen, argon, and helium.

7: The method of claim 1, wherein a flow rate of the dodecane-containing fluid to the water vapor stream introduced into the reactor is about 8:1 to 1:2.

8: The method of claim 1, wherein the passing of the dodecane-containing fluid and the water vapor stream through the reactor is performed at a temperature of about 700° C.

9: The method of claim 1, wherein the dodecane-containing fluid comprises one or more C8 to C25 aliphatic hydrocarbons.

10: The method of claim 9, wherein the dodecane-containing fluid consists of dodecane.

11: The method of claim 1, wherein the dodecane-containing fluid consists of dodecane, and wherein the residue gas stream comprises H₂, methane (CH₄), carbon monoxide (CO), carbon dioxide (CO₂), or mixtures thereof.

12: The method of claim 1, wherein the Ni-SRM catalyst is in the form of aggregated Ni particles disposed on porous surfaces of red mud particles.

13: The method of claim 1, wherein the Ni-SRM catalyst has a Brunauer-Emmett-Teller (BET) surface of 5 to 15 cubic meters per gram (m³/g).

14: The method of claim 1, wherein the Ni-SRM catalyst comprises hematite (Fe₂O₃), nickel ferrite (NiFe₂O₄), quartzite (SiO₂), calcium silicon oxide (Ca₂SiO₄), calcium aluminum oxide (Ca₃Al₂O₆), aluminum oxide (Al₂O₃), magnetite (Fe₂O₄), hercynite (FeAl₂O₄), nickel (Ni), nickel oxide (NiO), nickel aluminate (NiAl₂O₄) as determined by X-ray diffraction (XRD) analysis.

15: The method of claim 1, wherein the method has a hydrocarbon conversion of at least to 85% based on an initial weight of the dodecane present in the dodecane-containing fluid, and wherein the method has a H₂ yield of 50 to 80% based on the hydrocarbon conversion.

16: The method of claim 1, wherein the acid is at least one selected from a group consisting of hydrochloric acid, nitric acid, sulfuric acid, sulfonic acid, phosphoric acid, or mixtures thereof.

17: The method of claim 16, wherein the nickel salt comprises nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

18: The method of claim 1, wherein the Ni-SRM catalyst precursor after the separating is calcined at a temperature of about 950° C.
